(19) United States
(12) Patent Application Publication
(10) Pub. No.: US 2026/0172511 A1
(43) Pub. Date: Jun. 18, 2026

(54) IMAGE PROCESSING APPARATUS AND METHOD, AND STORAGE MEDIUM

(71) Applicant: CANON KABUSHIKI KAISHA, Tokyo (JP)

(72) Inventor: RYUSUKE OKUHARA, Kanagawa (JP)

(21) Appl. No.: 19/535,279

(22) Filed: Feb. 10, 2026

Related U.S. Application Data
(63) Continuation of application No. PCT/JP2024/028746, filed on Aug. 9, 2024.

(30) Foreign Application Priority Data
Aug. 29, 2023 (JP) 2023-139119

(51) Int. Cl. H04N 1/00

(52) U.S. Cl. CPC H04N 1/00456

(57) ABSTRACT

An image processing apparatus comprises: a reception unit that receives an operation by a user; and a display control unit that controls to display on a display device a display screen on which a layout selection area for selecting a layout in which images are to be arranged and an image selection area for selecting an image to be arranged in the layout are arranged, wherein the display control unit changes selectable layouts in the layout selection area in response to a change in selection of images in the image selection area by a user operation, and controls to display, as the selectable layouts, layouts in which images equal to or greater than the number of selected images selected in the image selection area can be arranged.

### CROSS-REFERENCE TO RELATED APPLICATIONS

This application is a Continuation of International Patent Application No. PCT/JP2024/028746, filed Aug. 9, 2024, which claims the benefit of Japanese Patent Application No. 2023-139119, filed Aug. 29, 2023, both of which are hereby incorporated by reference herein in their entirety.

### BACKGROUND

### Field of the Technology

The present disclosure relates to an image processing apparatus and method, and storage medium and more particularly to an image processing apparatus and method, and program for laying out images obtained by image shooting or the like.

### Description of the Related Art

Conventionally, there has been a printing system capable of arranging and printing a plurality of photographic images taken by an image capturing apparatus on a single sheet of paper (see Japanese Patent Laid-Open No. 2005-35280).

However, in the printing system described in Japanese Patent Laid-Open No. 2005-35280, an image selection screen and a layout selection/preview screen for layout printing, in which a plurality of images are arranged on one sheet of paper, are different screens, making operation very cumbersome. For example, if the preview for printing is something not desired by a user when checking the preview after selecting images and a layout, and if the user wants to reselect images, the user must return to the image selection screen.

The present disclosure has been made in consideration of the above problems, and has as its object to make it easier to select a layout and images to be arranged.

### SUMMARY

In order to achieve the above object, an image processing apparatus of the present disclosure comprises one or more processors and/or circuitry which function as: a reception unit that receives an operation by a user; and a display control unit that controls to display on a display device a display screen on which a layout selection area for selecting a layout in which images are to be arranged and an image selection area for selecting an image to be arranged in the layout are arranged, wherein the display control unit changes selectable layouts in the layout selection area in response to a change in selection of images in the image selection area by a user operation, and controls to display, as the selectable layouts, layouts in which images equal to or greater than the number of selected images selected in the image selection area can be arranged.

Features of the present disclosure will become apparent from the following description of embodiments with reference to the attached drawings.

### BRIEF DESCRIPTION OF THE DRAWINGS

FIG. 1 is a diagram illustrating the configuration of a printing system according to an embodiment of the present disclosure.

FIG. 2A is a diagram illustrating an example of the functional configuration and appearance of a mobile device, which is an example of an image processing apparatus according to the embodiment.

FIG. 2B is a diagram illustrating an example of the functional configuration and appearance of the mobile device, which is an example of an image processing apparatus according to the embodiment.

FIG. 3 is a diagram illustrating examples of images according to the embodiment.

FIG. 4A is a diagram illustrating examples of layouts and examples of laid-out images that can be used in a layout printing application according to the embodiment.

FIG. 4B is a diagram illustrating the examples of layouts and examples of laid-out images that can be used in the layout printing application according to the embodiment.

FIG. 5 is a diagram illustrating an example of a layout/image selection screen of the layout printing application according to the embodiment.

FIG. 6A is a diagram illustrating screen transitions during a layout selection operation according to the embodiment.

FIG. 6B is a diagram illustrating screen transitions during a layout selection operation according to the embodiment.

FIG. 6C is a diagram illustrating screen transitions during a layout selection operation according to the embodiment.

FIG. 6D is a diagram illustrating screen transitions during a layout selection operation according to the embodiment.

FIG. 6E is a diagram illustrating screen transitions during a layout selection operation according to the embodiment.

FIG. 6F is a diagram illustrating screen transitions during a layout selection operation according to the embodiment.

FIG. 6G is a diagram illustrating screen transitions during a layout selection operation according to the embodiment.

FIG. 6H is a diagram illustrating screen transitions during a layout selection operation according to the embodiment.

FIG. 7A is a diagram illustrating screen transitions in a case where the number of selected images increases upon selecting images according to the embodiment.

FIG. 7B is a diagram illustrating screen transitions in a case where the number of selected images increases upon selecting images according to the embodiment.

FIG. 7C is a diagram illustrating screen transitions in a case where the number of selected images increases upon selecting images according to the embodiment.

FIG. 7D is a diagram illustrating screen transitions in a case where the number of selected images increases upon selecting images according to the embodiment.

FIG. 8A is a diagram illustrating screen transitions in a case where the number of selected images decreases upon selecting images according to the embodiment.

FIG. 8B is a diagram illustrating screen transitions in a case where the number of selected images decreases upon selecting images according to the embodiment.

FIG. 8C is a diagram illustrating screen transitions in a case where the number of selected images decreases upon selecting images according to the embodiment.

FIG. 8D is a diagram illustrating screen transitions in a case where the number of selected images decreases upon selecting images according to the embodiment.

FIG. 9A is a diagram illustrating quick preview images to be stored in working memory according to the embodiment.

FIG. 9B is a diagram illustrating quick preview images to be stored in working memory according to the embodiment.

FIG. 10 is a flowchart illustrating the display processing of the layout/image selection screen by the layout printing application according to the embodiment.

FIG. 11 is a diagram illustrating an example of an initial screen of the layout/image selection screen according to the embodiment.

### DESCRIPTION OF THE EMBODIMENTS

Hereinafter, embodiments will be described in detail with reference to the accompanying drawings. Note, the following embodiments are not intended to limit the scope of the claimed invention. Multiple features are described in the embodiments, but limitation is not made to an invention that requires all such features, and multiple such features may be combined as appropriate. Furthermore, in the accompanying drawings, the same reference numerals are given to the same or similar configurations, and redundant description thereof is omitted.

### First Embodiment

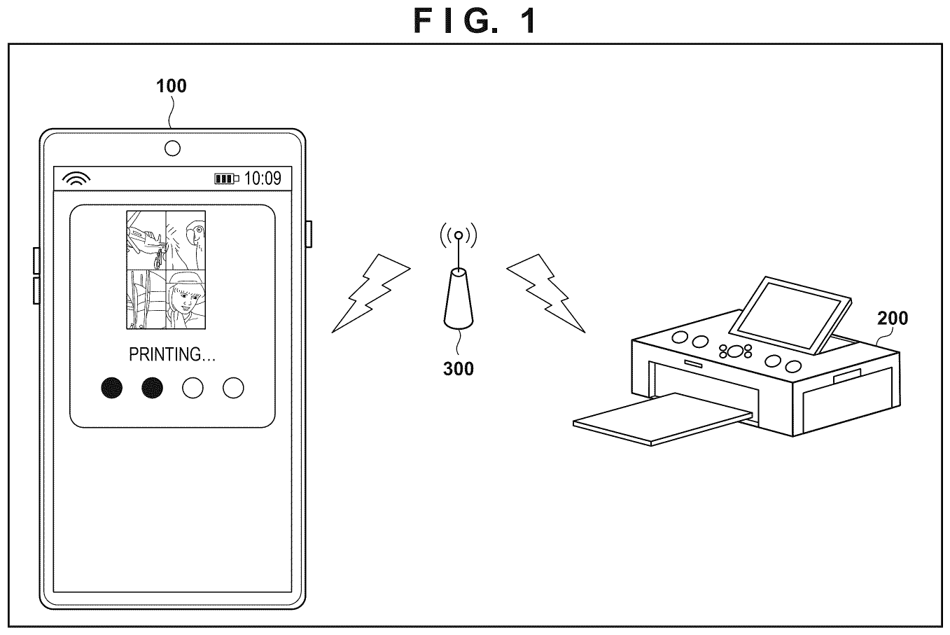

FIG. 1 is a diagram illustrating an example of a printing system according to this embodiment, showing a configuration consisting of a mobile device 100, which is an example of an image processing apparatus according to this embodiment, and a printing apparatus 200. Print data generated using a layout printing application according to this embodiment executed on the mobile device 100 is sent to the printing apparatus 200 and can be printed by the printing apparatus 200.

Communication between the mobile device 100 and the printing apparatus 200 may be wireless communication such as wireless LAN (Local Area Network), or wired communication such as USB (Universal Serial Bus) or Ethernet. Furthermore, in a case where a wireless LAN is used for communication between the mobile device 100 and the printing apparatus 200, communication may be performed via a router 300 having a wireless LAN access point separate from the mobile device 100 and the printing apparatus 200. Alternatively, the mobile device 100 or the printing apparatus 200 may be provided with a simple wireless LAN router function, and the mobile device 100 and the printing apparatus 200 may communicate using this wireless LAN router function.

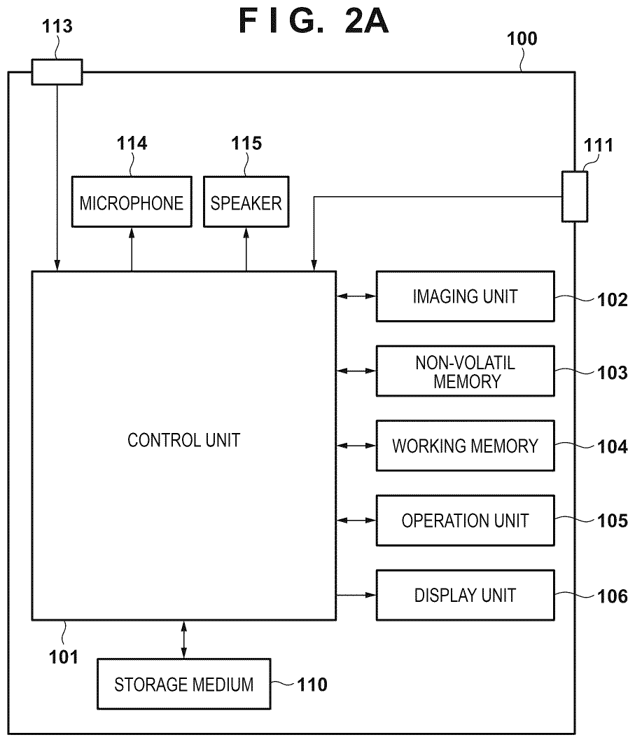

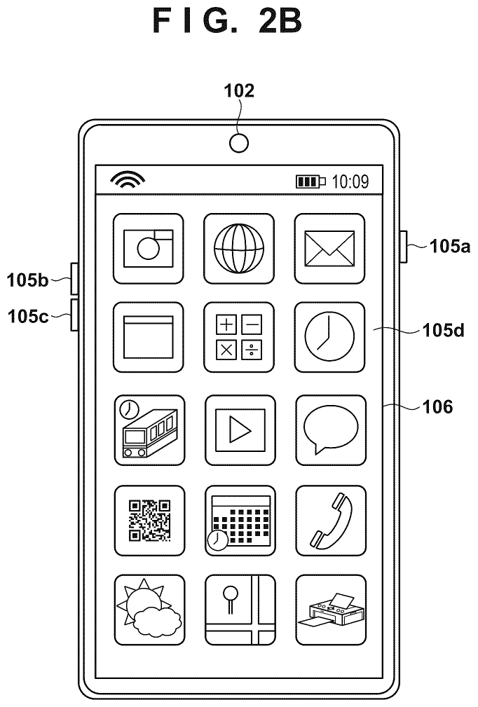

Next, referring to FIGS. 2A and 2B, an outline of the configuration and functions of the mobile device 100 such as a smartphone or tablet device will be described as an example of a device to which the image processing apparatus of this embodiment is applied. Note that in addition to smartphones and tablet devices, the present disclosure can also be applied to devices such as digital cameras, portable media players, personal computers, and game consoles as image processing apparatus.

FIG. 2A is a block diagram illustrating the functional configuration of the mobile device 100, and FIG. 2B is a diagram illustrating an example of the external appearance of the mobile device 100 as seen from the front.

In FIG. 2A, a control unit 101 controls each unit of the mobile device 100 in accordance with input signals and programs stored in a non-volatile memory 103. Note that instead of the control unit 101 controlling the entire mobile device 100, a plurality of hardware components may share the processing load to control the entire mobile device 100.

An imaging unit 102 converts light from a subject formed by the lens included in the imaging unit 102 into an electrical signal, performs signal processing such as noise reduction and A/D conversion, and outputs the resulting digital data as image data. The image data thus obtained is stored in a working memory 104 used as a buffer memory, undergoes predetermined image processing in the control unit 101, and is then recorded on a storage medium 110. It is also possible to save the captured image data to an external storage device using an online storage service, including a social networking service on the Internet, via a public network connection unit 113 or a connection unit 111. When saving image data to an external storage device using an online storage service, OS (Operating System) of the mobile device 100 or an installed application may automatically upload all images, or only images specified by the user may be uploaded.

The non-volatile memory 103 is electrically erasable and recordable non-volatile memory, and stores various programs executed by the control unit 101. A layout printing program of this embodiment is also stored in the non-volatile memory 103 and installed as the layout printing application. The layout printing application may be installed in the storage medium 110. The processing of the mobile device 100 in this embodiment is realized by loading the layout printing application. The layout printing application also has a program for utilizing the basic functions of the OS installed in the mobile device 100. The OS of the mobile device 100 may also have a program for realizing the processing of this embodiment.

The working memory 104 is used as a buffer memory for temporarily storing image data generated by the imaging unit 102, as image display memory for a display unit 106, and as a work area for the control unit 101. In the layout printing application of this embodiment, the working memory 104 is also used as a temporary storage destination for quick preview images, which will be described later.

An operation unit 105 is used to receive instructions from the user to the mobile device 100. The operation unit 105 includes operation members such as a power button 105a for turning on/off the power of the mobile device 100 shown in FIG. 2B, a volume up button 105b, a volume down button 105c, and a touch panel 105d formed on the display unit 106.

The display unit 106 displays image data, characters for interactive operations, icons for various application operations, etc. The display unit 106 does not necessarily have to be built into the mobile device 100. In other words, the mobile device 100 only needs to be able to connect to an external display unit 106 and have at least a display control function for controlling the display of the display unit 106.

The storage medium 110 can record image data output from the imaging unit 102 as an image file. The storage medium 110 may be configured to be detachable from the mobile device 100, or may be built into the mobile device 100. In other words, the mobile device 100 only needs to have at least a means for accessing the storage medium 110.

The non-volatile memory 103 and the storage medium 110 do not necessarily have to be configured as independent hardware components, and the non-volatile memory 103 may have the functions of the storage medium 110 described in this embodiment. Also, as described above, the layout printing application of this embodiment may be installed in the storage medium 110.

The connection unit 111 is an interface for communicating with other devices including the printing apparatus 200. The mobile device 100 of this embodiment can exchange data with the printing apparatus 200 via the connection unit 111. In this embodiment, the connection unit 111 includes an interface for communicating with the printing apparatus 200 via a wireless LAN, and the control unit 101 controls the connection unit 111 to realize wireless LAN communication with the printing apparatus 200.

The public network connection unit 113 is an interface used for public wireless communication. The mobile device 100 can make calls and perform data communication with other devices via the public network connection unit 113. During calls, the control unit 101 inputs and outputs audio signals via a microphone 114 and a speaker 115. The public network connection unit 113 includes an interface for communication using 4G. Note that other communication methods, such as LTE, WiMAX, ADSL, FTTH, so-called 3G, and 5G, may also be used instead of 4G. Furthermore, the connection unit 111 and the public network connection unit 113 do not necessarily need to be configured as independent hardware components; for example, a single antenna may be used for both.

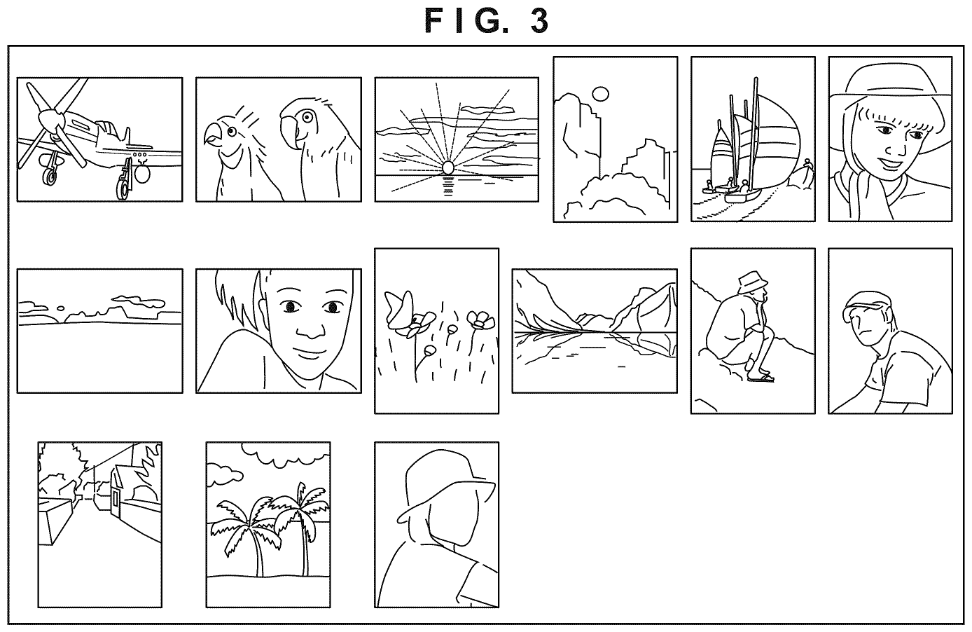

FIG. 3 shows examples of images stored in the storage medium 110 of the mobile device 100.

The layout printing application in this embodiment reads out these images from the storage medium 110, processes them to match the printing paper to be used in the printing apparatus 200 and the layout (described below), and generates print data.

Note that FIG. 3 shows only 15 images, but the actual storage medium 110 of the mobile device 100 may sometimes store more than several thousand image files. These image files may be stored in the non-volatile memory 103 of the mobile device 100, or may be stored in a device other than the mobile device 100 or in an external storage device provided by an online storage service. In the latter case, the image data may be downloaded from the external storage device to the non-volatile memory 103 or the working memory 104 via the connection unit 111 or the public network connection unit 113 and used.

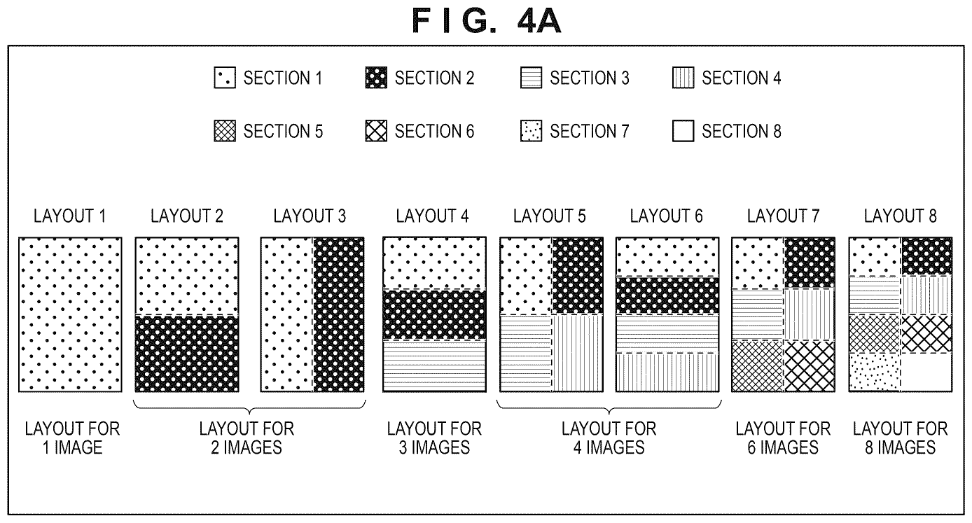

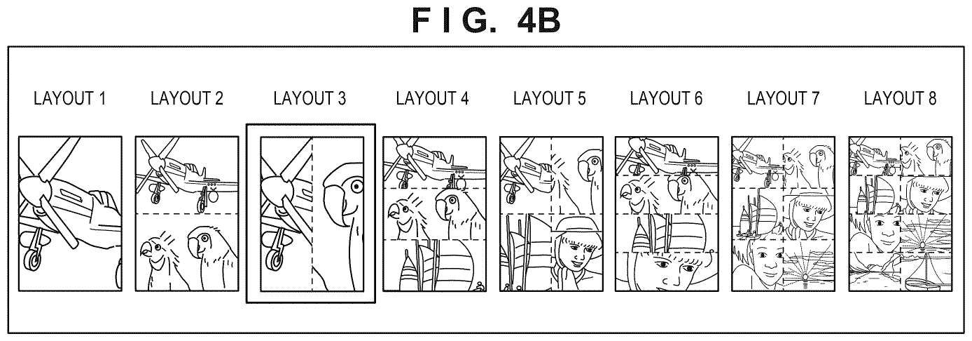

FIG. 4A is a diagram illustrating examples of layouts that can be used with the layout printing application of this embodiment.

The layout printing application of this embodiment sets an image selected by the user to each section of each layout, creating layout images such as those shown in FIG. 4B, which can then be printed using the printing apparatus 200.

FIG. 4A shows eight types of layouts, layout 1 to layout 8, as examples, but the present disclosure is not limited to eight types and may have more or less than eight types. Furthermore, the designs of layouts are not limited to those shown in FIG. 4A and any layout having an arbitrary design can be used. Furthermore, the layouts may be changed depending on settings in the layout printing application, such as the type of printing apparatus 200 and the paper size used for printing by the printing apparatus 200.

Next, the explanation will be given of the layout printing application that runs on the mobile device 100 in this embodiment.

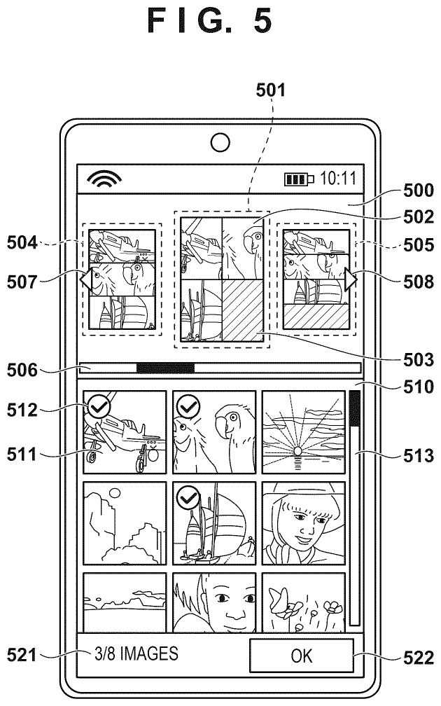

FIG. 5 is a diagram illustrating an example of a layout/image selection screen (display image) in the layout printing application of this embodiment.

In FIG. 5, a layout selection area 500 is an area for selecting a layout from the layouts 1 to 8 shown in FIG. 4A in the layout printing application. In the layout selection area 500, layouts are displayed in three candidate layout display areas: a main candidate layout display area 501, a preceding candidate layout display area 504, and a next candidate layout display area 505. The layouts displayed in the main candidate layout display area 501, the preceding candidate layout display area 504, and the next candidate layout display area 505 can be switched sequentially by operating a scroll bar 506, using a display layout switching button 507 or 508, or swiping the layout selection area 500. The multiple layouts displayed in the layout selection area 500 are displayed in order of the number of images that can be arranged in each layout.

The layout displayed in the main candidate layout display area 501 is the currently selected layout, and therefore it is desirable to display it in a way that makes it stand out compared to the layouts displayed in the preceding candidate layout display area 504 and the next candidate layout display area 505. Possible methods for making it stand out include, for example, displaying the layout in the main candidate layout display area 501 larger than the other layouts, or displaying a special frame around the main candidate layout display area 501. Other possible methods include, for example, shading the layout display areas other than the main candidate layout display area 501, or displaying them in a lighter color.

An image selection area 510 is an area for displaying thumbnail images of image data that can be used for layout to select images to be laid out. Image data in the non-volatile memory 103 and the storage medium 110 in the mobile device 100 is searched, and image data that can be used for layout is displayed side by side in the image selection area 510. The image data of all images in the non-volatile memory 103 and the storage medium 110 may be obtained, or of images in only one of the non-volatile memory 103 or the storage medium 110 may be obtained. Furthermore, a folder from which image data is obtained may be specified by the application, or by the user. Furthermore, as described above, image data may be obtained from another device or an external storage device of an online storage service via the connection unit 111 or the public network connection unit 113.

The order in which the thumbnail images are displayed may be the order in which the image data was found, or may be sorted and displayed in order of the date the image data was taken, created, or updated. In addition, in the description of this embodiment, when an image is displayed in the image selection area 510, it is resized and displayed after being cropped into a square like a thumbnail image 511, but it is also possible to resize and display the image without cropping.

When the user performs an operation to select an image, such as tapping on the touch panel 105d, an image selection mark 512 is displayed to indicate that the image is selected, and quick preview images are displayed in which the selected image is fitted into an empty section of each layout currently displayed in the layout selection area 500.

Furthermore, when an operation to deselect a selected image, such as by tapping on the touch panel 105d, the image selection mark 512 is hidden, and quick preview images are displayed in which the deselected image is deleted from the quick preview image of each layout displayed in the layout selection area 500.

Then, by pressing an OK button 522, the layout shown in the main candidate layout display area 501 and the selected image/images can be confirmed.

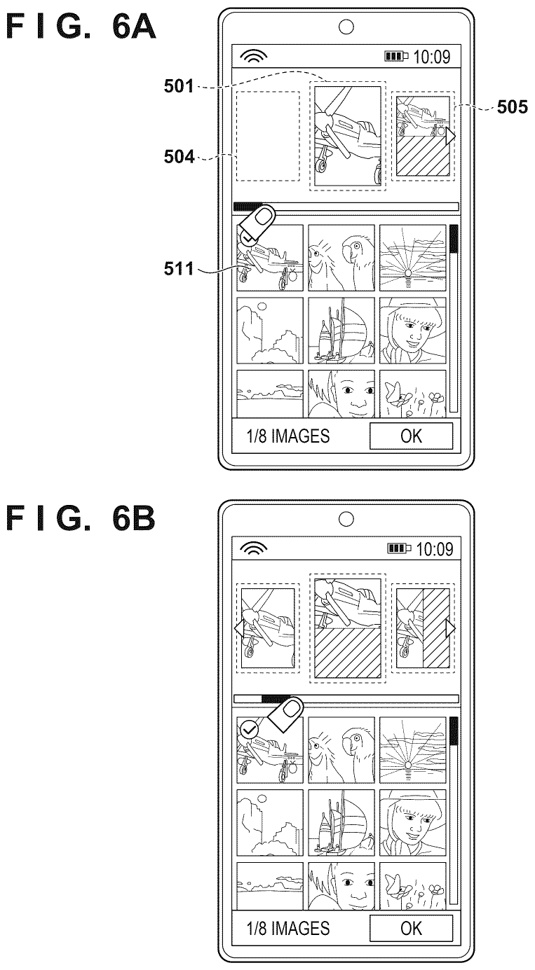

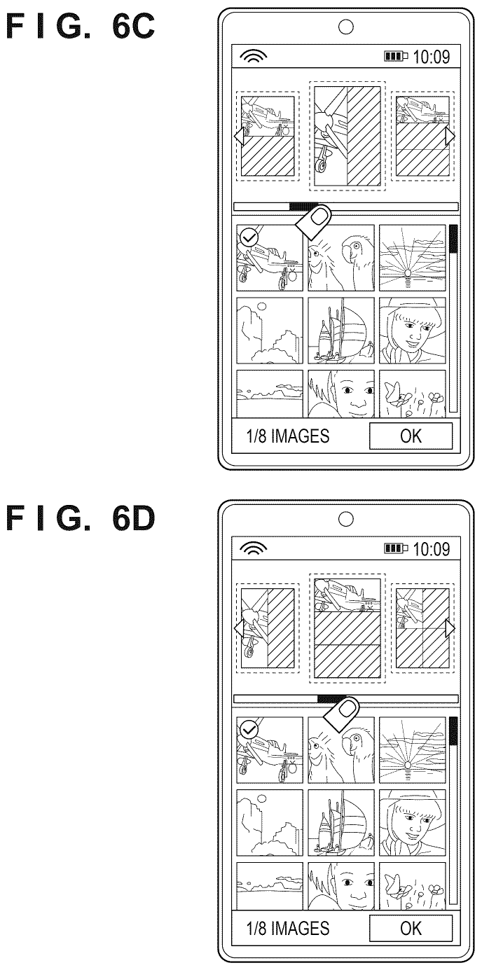

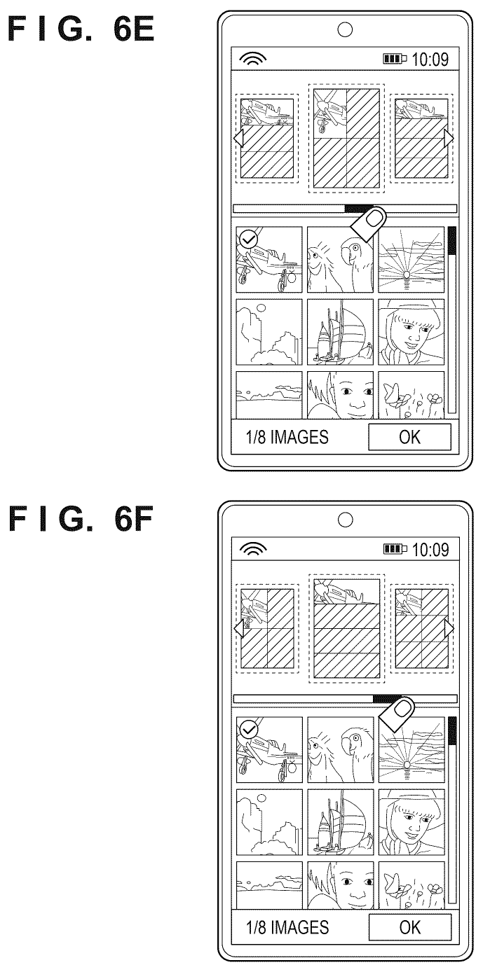

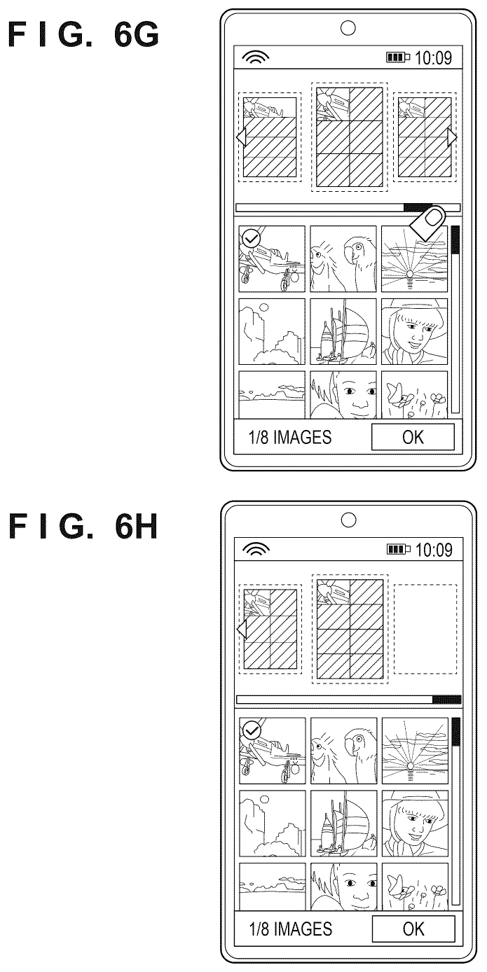

FIGS. 6A to 6H are diagrams showing screen transitions during a layout selection operation, and illustrate a case in which the layouts 1 to 8 shown in FIG. 4A are displayed in order in the main candidate layout display area 501.

FIG. 6A shows a screen in which the layout 1 is displayed in the main candidate layout display area 501, the layout 2 is displayed in the next candidate layout display area 505, and a thumbnail image 511 is selected. In this state, when an instruction to advance to the next layout is given by operating the scroll bar 506 or the display layout switching button 508, or by a swipe operation on the layout selection area 500, or the like, the screen transitions to the screen shown in FIG. 6B. FIG. 6B shows a state in which the layout 2 is displayed in the main candidate layout display area 501, the layout 1 is displayed in the preceding candidate layout display area 504, and the layout 3 is displayed in the next candidate layout display area 505. An image corresponding to the selected thumbnail image 511 is displayed in section 1 of each layout.

Similarly, each time an instruction to advance to the next layout is given, the layout displayed in the main candidate layout display area 501 is changed sequentially from the layout 3 to the layout 8, as shown in FIGS. 6C to 6H. Furthermore, in the preceding candidate layout display area 504 and the next candidate layout display area 505, the layouts before and after the layout displayed in the main candidate layout display area 501 are respectively displayed.

Conversely, when an instruction to return to the previous layout is given by operating the scroll bar 506 or the display layout switching button 508, or by swiping the layout selection area 500, the layout displayed in the main candidate layout display area 501 is changed to the preceding layout, and the layouts before and after the layout displayed in the main candidate layout display area 501 are displayed in the preceding candidate layout display area 504 and the next candidate layout display area 505. In this way, the user can select a desired layout.

In FIG. 6A, the layout 2 is displayed in the next candidate layout display area 505, but because the selection candidate layout is the layout 1, which is the first layout, no layout is displayed in the preceding candidate layout display area 504. However, the present disclosure is not limited to this, and the order of layouts to be displayed may be looped, and when the first layout is displayed in the main candidate layout display area 501, the last layout 8 may be displayed in the preceding candidate layout display area 504. Similarly, in the example shown in FIG. 6H, the layout 1 may be displayed in the next candidate layout display area 505.

Next, the screen transitions when selecting an image will be explained.

In respective sections of each layout displayed in the layout selection area 500, images corresponding to thumbnail images selected from the thumbnail images displayed in the image selection area 510 are placed in the selected order. At this time, if the aspect ratio of each section differs from that of the selected image, a “fill” placement in which the image is cut to match the aspect ratio of the section is used in this embodiment; however, a “fit” placement in which the image is placed so that it is inscribed in the section may also be used. Furthermore, for sections in which no image has been placed, diagonal lines or the like are displayed, as in an empty section 503 in FIG. 5, to indicate that no image is arranged.

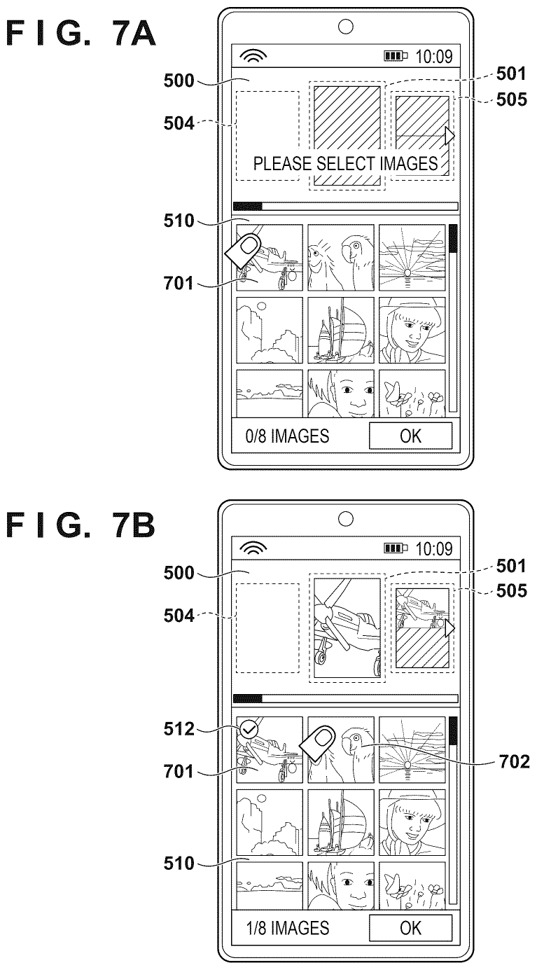

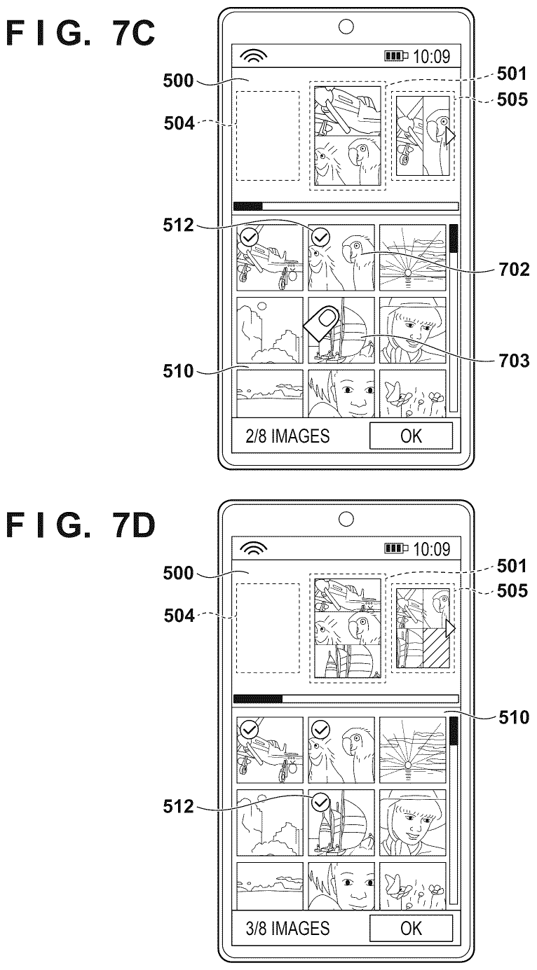

First, a case in which the number of selected images increases will be explained. FIGS. 7A to 7D are diagrams showing the screen transitions when the number of selected images increases.

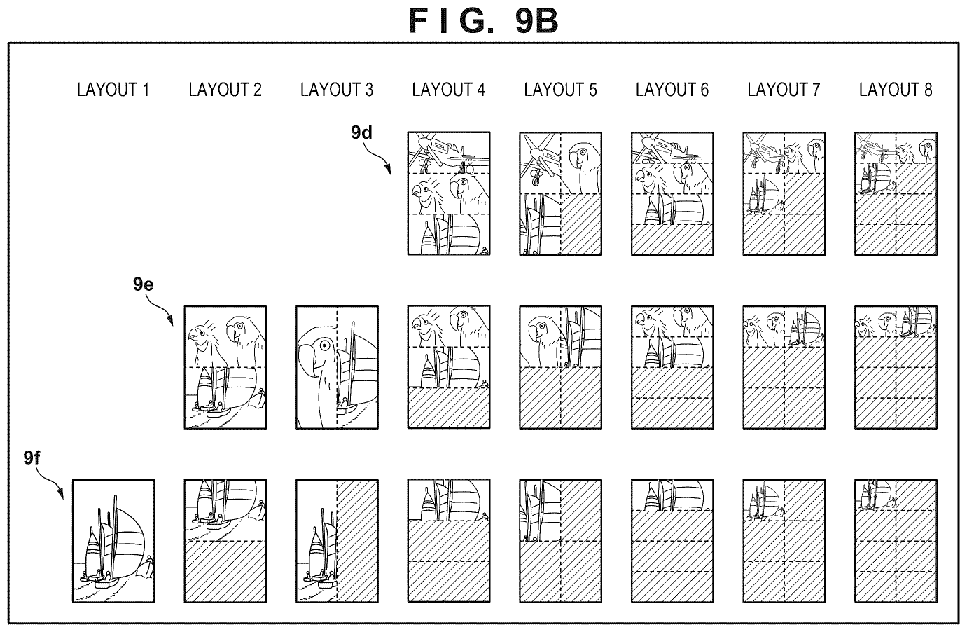

FIG. 7A shows a screen where no images are selected and the layout 1 is displayed in the main candidate layout display area 501. Here, as shown in 9a of FIG. 9A, a quick preview image in which no images are selected may be generated for each layout and stored in the working memory 104. This allows for quick display switching when switching layouts as shown in FIGS. 6A to 6H.

On the screen of FIG. 7A, when a thumbnail image 701 displayed in the image selection area 510 is tapped, the image selection mark 512 is displayed on the thumbnail image 701, as shown in FIG. 7B. Furthermore, quick preview images in which the selected image is fitted into the section 1 of the layout 1 displayed in the main candidate layout display area 501 and the section 1 of the layout 2 displayed in the next candidate layout display area 505 are generated and displayed.

At this time, as shown in 9b of FIG. 9A, quick preview images may be generated in which the selected image is set to the section 1 of all layouts from the layout 3 onwards, which are not displayed on the screen of FIG. 7A, and saved in the working memory 104, thereby enabling quick switching of the display when switching between the layouts shown in FIGS. 6A to 6H.

Next, when a thumbnail image 702 is further tapped on the screen of FIG. 7B, as shown in FIG. 7C, the image selection mark 512 is displayed above the thumbnail image 702 and each of the quick preview images displayed in the layout selection area 500 is updated.

In this case, the layout 1 has only one section in which an image can be placed, and therefore the two selected images cannot be placed therein, so it is removed from a list of layouts to be displayed in the layout selection area 500. In other words, when two images are selected, the layouts 2 to 8 are the selectable layouts, as shown in 9c of FIG. 9A, and quick preview images are generated and displayed in which the image of the selected thumbnail image 702 is placed in the section 2 of each layout. At this time, because the layout 1, which was displayed in the main candidate layout display area 501, is removed from the list of layouts to be displayed, a quick preview image of the next layout, the layout 2, is displayed in the main candidate layout display area 501. Furthermore, a quick preview image of the next layout 3 is displayed in the next candidate layout display area 505.

In a screen shown in FIG. 7C, if a thumbnail image 703 is further tapped, as shown in FIG. 7D, the image selection mark 512 is displayed above the thumbnail image 703, and the respective quick preview images displayed in the layout selection area 500 are also updated. As when the number of selected images increases to two, when three images are selected, layouts with two or fewer sections are removed from the list of layouts to be displayed in the layout selection area 500. That is, in addition to the layout 1, the layouts 2 and 3 are also removed from the list of layouts to be displayed, and the layouts 4 to 8 are selectable layouts as shown in 9d of FIG. 9B, and quick preview images are generated in which the image of the thumbnail image 703 is placed in the section 3 of each layout. In this case, the layout 2, which was displayed in the main candidate layout display area 501, and the layout 3, which was displayed in the next candidate layout display area 505, are excluded from the list of layouts to be displayed, and therefore the quick preview image of the next layout, i.e., the layout 4, is displayed in the main candidate layout display area 501. Furthermore, the quick preview image of the next layout 5 is displayed in the next candidate layout display area 505. Similarly, each time a thumbnail image is selected, the corresponding image is placed in an empty section, and the layouts with insufficient number of sections are removed from the selectable layouts.

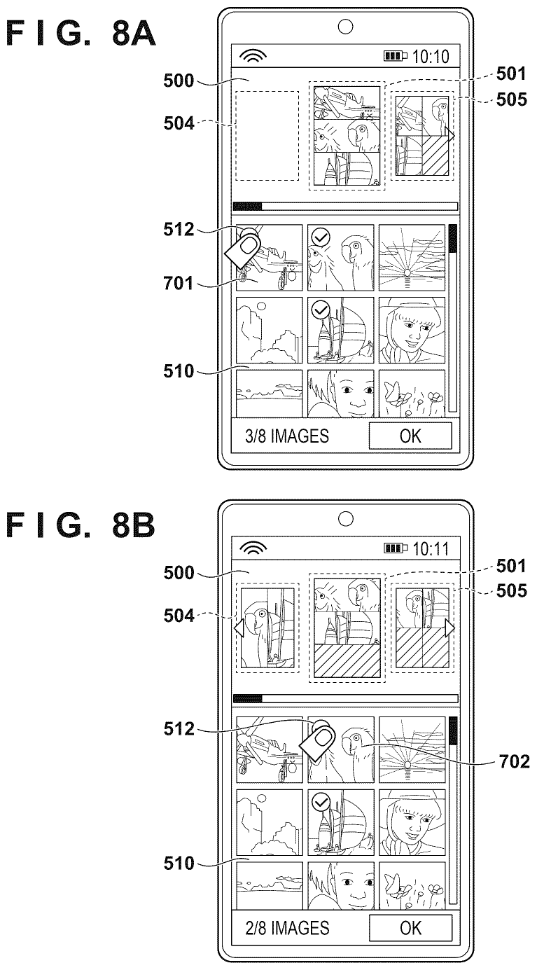

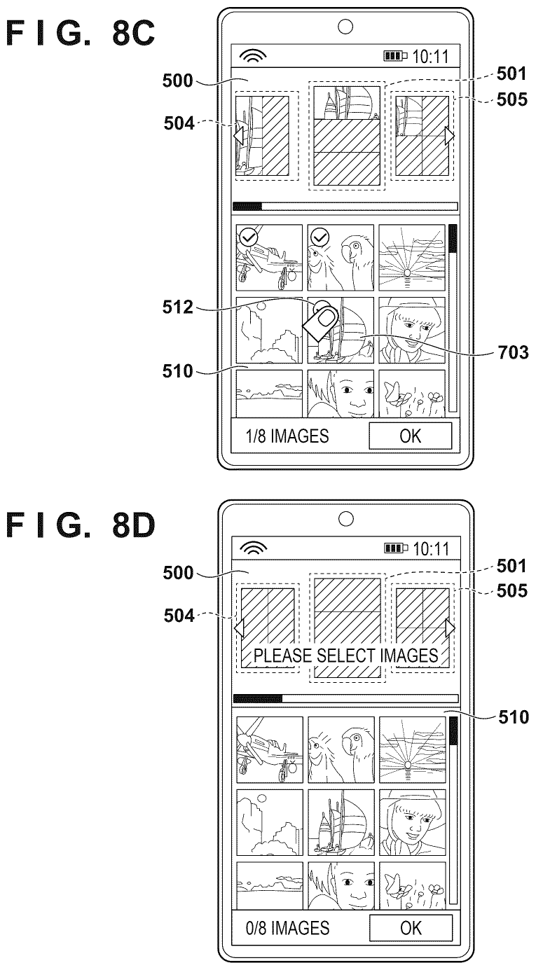

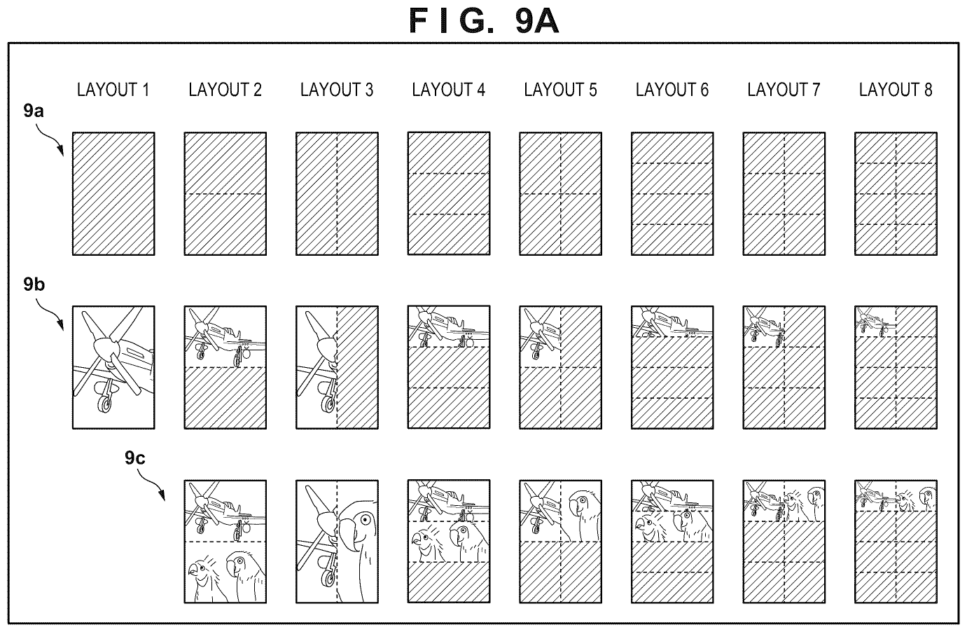

Next, a case in which an image is deselected will be explained. FIGS. 8A to 8D are diagrams showing the screen transitions when the number of selected images decreases.

FIG. 8A shows the same screen as FIG. 7D. On this screen, the selected thumbnail image 701 is tapped, and FIG. 8B shows the state when the selection is cancelled. In this case, the image selection mark 512 on the thumbnail image 701 is hidden, and each quick preview image displayed in the layout selection area 500 is updated. At this time, as the number of selected images is reduced to two, so the layouts 2 and 3, which had been removed from the list of layouts to be displayed, are once again included in the list. Also, because the thumbnail image 701 is deselected, the image selection order changes so that the thumbnail image 702 comes first and the thumbnail image 703 comes second. Arranging the images in this order, starting from the section 1 of each layout, results in the quick preview images shown in 9e of FIG. 9B.

At this time, the layout 4 displayed in FIG. 8A continues to be in the list of layouts to be displayed, and therefore, in FIG. 8B, the layout 4 is also displayed in the main candidate layout display area 501. Furthermore, the layout 3, which is again included in the list of layouts to be displayed, is displayed in the preceding candidate layout display area 504.

In other words, if the number of selected images increases or decreases, and if the layout that was displayed before the image was selected/deselected remains in the list of layouts to be displayed, that layout continues to be displayed in the main candidate layout display area 501, and if the layout is removed from the list of layouts to be displayed, the next layout to be displayed is displayed in the main candidate layout display area 501.

FIG. 8C shows a state in which the selected thumbnail image 702 in FIG. 8B is tapped and deselected. In this case, the image selection mark 512 on the thumbnail image 702 is hidden, and each quick preview image displayed in the layout selection area 500 is updated. At this time, the number of selected images has been reduced to one, and the layout 1, which had been removed from the list of layouts to be displayed, is once again included in the list of layouts to be displayed. Furthermore, with the thumbnail image 702 is deselected, only the thumbnail image 703 remains selected. Therefore, when the image of the thumbnail image 703 is placed in the section 1 of each layout, quick preview images such as those shown in 9f of FIG. 9B are obtained.

At this time, the layout 4 displayed in FIG. 8B continues to be in the list of layouts to be displayed, and therefore, in FIG. 8C, the layout 4 is continuously displayed in the main candidate layout display area 501. Furthermore, the layout 3 continues to be displayed in the preceding candidate layout display area 504.

Finally, FIG. 8D shows a state in which the selected thumbnail image 703 in FIG. 8C is tapped and deselected. In this case, the image selection mark 512 on the thumbnail image 703 is hidden, and each quick preview image displayed in the layout selection area 500 is updated. At this time, since the thumbnail image 703 is deselected and thus all the thumbnail images are deselected, the quick preview images return to those shown in 9a in FIG. 9A, in which no images are placed in each layout, and are displayed.

As described above, by narrowing down the selectable layouts in accordance with the number of images selected by the user, the user can easily select a layout in which the selected images can be arranged.

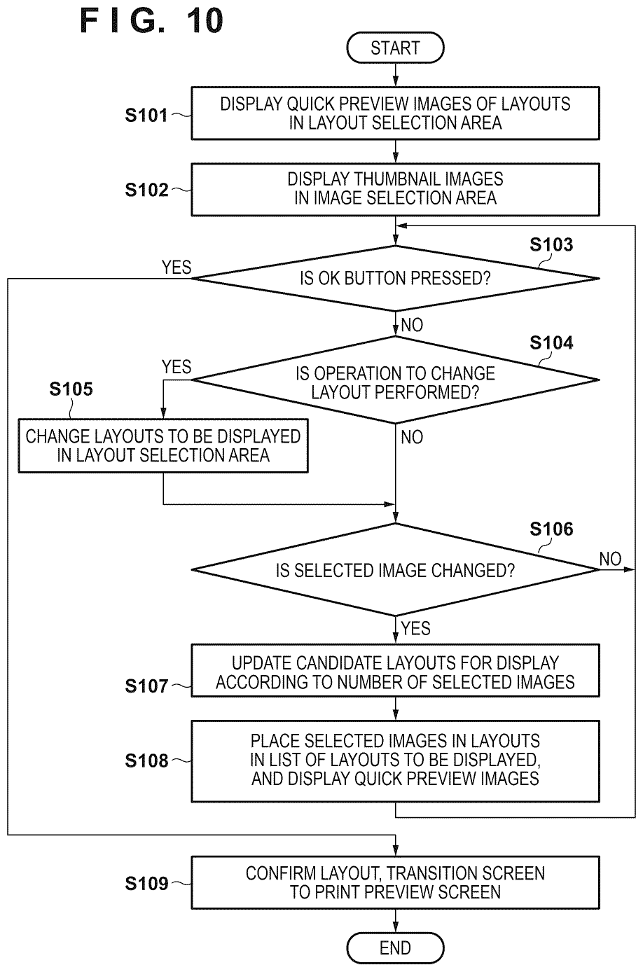

Next, the display processing of the layout/image selection screen by the layout printing application in this embodiment will be described with reference to the flowchart in FIG. 10.

The flowchart shown in FIG. 10 starts with the layout printing application of this embodiment being launched and the layout/image selection screen being displayed. The process shown in FIG. 10 is performed by the control unit 101 of the mobile device 100 executing the layout printing application.

In step S101, the layout printing application displays available layouts in the layout selection area 500. At this time, as described above, available layouts may be selected according to the current settings such as the printer type, size and type of paper, etc. Specifically, first, as shown in 9a in FIG. 9A, quick preview images representing a state in which no image is set in each section of each layout are generated and saved in the working memory 104. Then, from among these, quick preview images of layouts to be displayed in the main candidate layout display area 501, the preceding candidate layout display area 504, and the next candidate layout display area 505 are displayed.

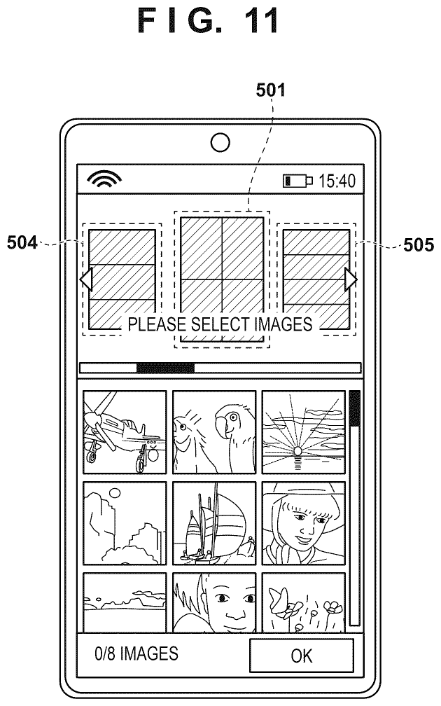

Immediately after the layout printing application is executed, as shown in FIG. 7A, the layout 1 is displayed in the main candidate layout display area 501, and the layout 2 is displayed in the next candidate layout display area 505. Furthermore, for example, if printing is performed using the layout 5 and then the screen transitions to the layout/image selection screen, the layout 5 may be continuously displayed in the main candidate layout display area 501, the layout 4 in the preceding candidate layout display area 504, and the layout 6 in the next candidate layout display area 505, as shown in FIG. 11.

Next, in step S102, thumbnail images of image data that can be used for printing, among the image data stored in the storage medium 110, etc., are displayed side by side in the image selection area 510.

Next, in step S103, it is determined whether or not the OK button 522 is selected. If it is determined that the OK button 522 is not selected, the process proceeds to step S104.

In step S104, it is determined whether an operation is performed to change the layout displayed in the layout selection area 500. If it is determined in step S104 that an operation is performed to change the display of the quick preview images, the process proceeds to step S105.

In step S105, the quick preview images stored in the working memory 104 are read in response to the user operation, and are displayed in the main candidate layout display area 501, the preceding candidate layout display area 504, and the next candidate layout display area 505, and the process proceeds to step S106.

On the other hand, if it is determined in step S104 that an operation to change the layout displayed in the layout selection area 500 is not performed, the process proceeds to step S106.

In step S106, it is determined whether a selection operation is performed by tapping on a thumbnail image displayed in the image selection area 510, or whether a deselection operation is performed by tapping on a thumbnail image of an already selected image.

If it is determined that no image selection operation or deselection operation is performed, the process returns to step S103 and monitors the user's operation again. On the other hand, if it is determined that an image selection operation or deselection operation is performed, the process proceeds to step S107.

In step S107, layouts to be displayed in the layout selection area 500 are selected from the layouts according to the number of images currently selected. Here, layouts that have a number of sections less than the number of selected images are excluded from the list of layouts to be displayed and are not displayed. In other words, as described with reference to FIGS. 7A to 7D, if the number of selected images is two, the layout 1 is excluded from the list of layouts to be displayed, and if the number of selected images is three, the layouts 2 and 3 in addition to the layout 1 are also excluded from the list of layouts to be displayed.

In step S108, the selected images are placed in order in the layouts in the list of layouts to be displayed in step S107 to generate quick preview images, and the quick preview images are saved in the working memory 104. Furthermore, the quick preview images of the layouts are displayed in the main candidate layout display area 501, the preceding candidate layout display area 504, and the next candidate layout display area 505, and the process returns to step S103, where user operations are monitored again.

If the number of selected images increases as a result of the image selection operation in step S106, the layout that was displayed in the main candidate layout display area 501 before the image selection operation in step S107 may become hidden and unavailable for selection. In this case, layouts that can accommodate the current number of selected images are displayed, and the currently selected layout is changed. At this time, a layout that lays out the same number of sections as the number of selected images is basically displayed in the main candidate layout display area 501. However, if there is no layout with the same number of sections, a layout with a number of sections equal to or greater than the number of selected images may be displayed in the main candidate layout display area 501. If the number of selected images decreases as a result of the deselection operation in step S106, the layout displayed in the main candidate layout display area 501 before the image selection operation is not changed, and the display of the quick preview images is changed in step S108.

Finally, if it is determined in step S103 that the OK button 522 is pressed, the process proceeds to step S109, where the layout displayed in the main candidate layout display area 501 and the selected image are confirmed, and the screen transitions to the print preview screen. On the print preview screen, the preview image is displayed at a larger display size than the quick preview image displayed in the main candidate layout display area 501, making it easier to check the images and print layout.

As described above, according to this embodiment, it is possible to select the layout and images to be arranged on a single layout/image selection screen, which makes it easier to select the layout and images to be arranged even on devices with small display screens.

In the above embodiment, an application that prints with a selected layout and images is described, but it does not necessarily have to print. For example, the application can be used for other purposes, such as uploading edited images to a SNS (social networking service).

The present disclosure makes it possible to more easily select images to be laid out and arranged.

### OTHER EMBODIMENTS

The present disclosure may be applied to a system consisting of multiple devices, or to a device consisting of a single device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image processing apparatus comprising one or more processors and/or circuitry which function as:
a reception unit that receives an operation by a user; and
a display control unit that controls to display on a display device a display screen on which a layout selection area for selecting a layout in which images are to be arranged and an image selection area for selecting an image to be arranged in the layout are arranged,
wherein the display control unit changes selectable layouts in the layout selection area in response to a change in selection of images in the image selection area by a user operation, and controls to display, as the selectable layouts, layouts in which images equal to or greater than the number of selected images selected in the image selection area can be arranged.

2. The image processing apparatus according to claim 1, wherein the display control unit changes the selectable layouts in the layout selection area in response to the change in the selection of images in the image selection area by the user operation, so that layouts in which the number of selected images selected in the image selection area are arranged are selectable.

3. The image processing apparatus according to claim 1, wherein the display control unit hides a layout in which only a number of images less than the number of selected images selected in the image selection area can be arranged, in response to the change in the selection of images in the image selection area by the user operation.

4. The image processing apparatus according to claim 1, wherein the display control unit controls the display of selectable layouts in the layout selection area in order of an available number of images that can be laid out.

5. The image processing apparatus according to claim 1, wherein the display control unit
displays a currently selected layout in the layout selection area in a distinguishing manner from other layouts, and
in a case where the currently selected layout becomes unselectable due to an increase in the number of selected images in response to the change in the selection of images, changes the currently selected layout to one of the layouts that can be selectable after the increase in the number of selected images.

6. The image processing apparatus according to claim 5, wherein in a case where the currently selected layout becomes unselectable due to an increase in the number of selected images, the display control unit controls to change the currently selected layout to a layout in which a same number of images as the increased number of selected images can be arranged.

7. The image processing apparatus according to claim 5, wherein in a case where a number of selected images is decreased in response to the change in the selection of images, the display control unit controls not to change a currently selected layout.

8. The image processing apparatus according to claim 1, wherein the display control unit controls to display quick previews in which the images selected in the image selection area are arranged in the layouts displayed in the layout selection area.

9. The image processing apparatus according to claim 8, wherein the display control unit controls to display on the display device a preview screen in which a preview of the image selected in the image selection area and arranged in the layout selected in the layout selection area is displayed at a display size larger than that of the quick previews, in response to a predetermined operation for confirming selection of layout in the layout selection area and the selection of images in the image selection area.

10. The image processing apparatus according to claim 1 further comprising:
a communication unit that performs communication; and
a generating unit that generates print data corresponding to a preview image of the selected layout when the reception unit receives an operation to confirm the selected layout,
wherein the print data is transmitted to a printing device via the communication unit.

11. The image processing apparatus according to claim 1, wherein the image processing apparatus is a mobile device, and
further comprises the display device.

12. An image processing method comprising:
controlling to display on a display device a display screen on which a layout selection area for selecting a layout in which images are to be arranged and an image selection area for selecting an image to be arranged in the layout are arranged;
receiving an operation by a user; and
changing selectable layouts in the layout selection area in response to a change in selection of images in the image selection area by a user operation, and controlling to display, as the selectable layouts, layouts in which images equal to or greater than the number of selected images selected in the image selection area can be arranged.

13. A non-transitory computer-readable storage medium, the storage medium storing a program that is executable by the computer, wherein the program includes program code for causing the computer to function as an image processing apparatus comprising:
a reception unit that receives an operation by a user; and
a display control unit that controls to display on a display device a display screen on which a layout selection area for selecting a layout in which images are to be arranged and an image selection area for selecting an image to be arranged in the layout are arranged,
wherein the display control unit changes selectable layouts in the layout selection area in response to a change in selection of images in the image selection area by a user operation, and controls to display, as the selectable layouts, layouts in which images equal to or greater than the number of selected images selected in the image selection area can be arranged.
